(19) United States
(12) Patent Application Publication
(10) Pub. No.: US 2006/0072664 A1
(43) Pub. Date: Apr. 6, 2006

(54) Display apparatus

(76) Inventors: Oh-jae Kwon, Anyang-si (KR); Han Feng Chen, Suwon-si (KR); Sung-hee Lee, Suwon-si (KR)

Correspondence Address: STANZIONE & KIM, LLP, 919 18TH STREET, N.W., SUITE 440, WASHINGTON, DC, 20006, US

(21) Appl. No.: 11/216,127

(22) Filed: Sep. 1, 2005

(30) Foreign Application Priority Data
Oct. 4, 2004 (KR) 2004-78852

(51) Int. Cl. H04N 11/02; H04N 5/14; H04N 7/12; H04N 9/64; H04B 1/66

(52) U.S. Cl. 375/240.16; 348/699

(57) ABSTRACT

A display apparatus includes a display panel; a motion estimator to divide a current frame into a plurality of blocks having a predetermined size, to calculate a plurality of motion prediction error values by comparing a current block for estimating a motion thereof with a searching region set in a previous frame among a plurality of blocks in the previous frame, and to estimate a provisional motion vector of the current block according to the plurality of motion prediction error values; a pattern determiner to determine whether the current block includes a pattern image according to the plurality of motion prediction error values; a compensation motion vector creator to create a compensation motion vector for the current block according to the plurality of motion prediction error values when the current block is determined to include the pattern image by the pattern determiner; a motion vector selector to select the compensation motion vector as a final motion vector of the current block when the current block is determined to include the pattern image by the pattern determiner, and to select the provisional motion vector as the final motion vector of the current block when the current block is not determined to include the pattern image by the pattern determiner; a motion compensator to create an intermediate frame according to the final motion vector and to insert the intermediate frame between the current frame and the previous frame; and a panel driver to display the previous frame, the intermediate frame, and the current frame on the display panel in sequence.

### CROSS-REFERENCE TO RELATED APPLICATIONS

This application claims the benefit of Korean Patent Application No. 2004-78852, filed on Oct. 4, 2004 in the Korean Intellectual Property Office, the disclosure of which is incorporated herein in its entirety by reference.

### BACKGROUND OF THE INVENTION

1. Field of the Invention

The present general inventive concept relates to a display apparatus, and more particularly, to a display apparatus, which enhances visual recognition for a moving picture, by estimating variation between two sequential frames and interpolating an intermediate frame based on a trajectory of the variation.

2. Description of the Related Art

In display apparatuses, and in particular, in liquid crystal displays (LCDs), looming large is securing visual recognition for a moving picture to realize a high quality picture. In a conventional liquid crystal display apparatus, a motion blur effect blurs objects in the moving picture, when the moving picture is displayed. In an attempt to solve this problem, a fast responsible liquid crystal, an overdriving method for fast reaching a target gradation, etc., have been used to improve a response speed for intermediate gradation in these display apparatuses.

The foregoing methods have achieved success in cathode ray tube (CRT) apparatuses. However, these methods have achieved limited success in securing the visual recognition for the moving picture in LCDs due to the motion blur effect.

Thus, since the motion blur effect occurs in the LCD display apparatus a method of applying an impulse type display control to the LCD display apparatus that is similar to a display control of the CRT display apparatus has been used in an attempt to mitigate the motion blur effect.

The impulse type display control includes a black frame insertion method or a backlight blinking method.

The black frame insertion method periodically resets the LCD display apparatus, and a black frame is inserted between two sequential frames while picture data is displayed, thereby alternating between the picture data and the black frame to represent characteristics of an impulse type display. The backlight blinking method alternately turns a backlight on and off at regular intervals, thereby representing a light emission state of the impulse type display. Thus, the impulse type display control mitigates the motion blur effect to some degree and improves the visual recognition for the moving picture.

However, the impulse type display control described above causes a screen of the LCD display apparatus to flicker and the brightness of the screen decreases.

The motion blur effect of the LCD display apparatus occurs; because a human eye recognizes a moving object by integrating an outline of the moving object, and the LCD display apparatus has characteristics of a hold type display. That is, as illustrated in FIG. 1, when the human eye sees the moving object in the moving picture, the human eye follows the outline of the moving object, thereby integrating pixel values of the moving picture along a moving direction of the moving object.

FIG. 1 illustrates a time integral of pixel values along a moving direction. As a moving object moves, pixel values duplicated along the moving direction are continuously integrated as in a still picture, so that an integrated pixel value is equal to a displayed pixel value (refer to “A” of FIG. 1). On the other hand, pixel values corresponding to an error area between a moving path of the moving object and a pixel value holding region are partially integrated along the moving direction, so that the integrated pixel value is smaller than the displayed pixel value (refer to “B” of FIG. 1). Consequently, a pixel value recognized by the human eye that follows the moving object is different from a real pixel value, thereby blurring a profile of the moving object and causing the motion blur effect. The motion blur effect increases with a speed of the moving object.

Therefore, a display apparatus in which the motion blur effect is minimized without deterioration of display characteristics (e.g., flickering of the screen, lowering of the brightness of the screen, etc.) is needed.

### SUMMARY OF THE INVENTION

Accordingly, the present general inventive concept provides a display apparatus in which an intermediate frame is created using a motion compensating method based on a real motion, and the intermediate frame is inserted between a current frame and a previous frame, thereby minimizing a motion blur effect.

The present general inventive concept also provides a display apparatus in which a motion vector underlying an intermediate frame is created to approximate a real motion.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a display apparatus comprising a display panel; a motion estimator to divide a current frame into a plurality of blocks having a predetermined size, to calculate a plurality of motion prediction error values by comparing a current block for estimating a motion thereof with a searching region set in a previous frame among a plurality of blocks in the previous frame, and to estimate a provisional motion vector of the current block according to the plurality of motion prediction error values; a pattern determiner to determine whether the current block includes a pattern image according to the plurality of motion prediction error values; a compensation motion vector creator to create a compensation motion vector for the current block according to the plurality of motion prediction error values when the current block is determined to include the pattern image by the pattern determiner; a motion vector selector to select the compensation motion vector as a final motion vector of the current block when the current block is determined to include the pattern image by the pattern determiner, and to select the provisional motion vector as the final motion vector of the current block when the current block is not determined to include the pattern image by the pattern determiner; a motion compensator to create an intermediate frame according to the final motion vector and to insert the intermediate frame between the current frame, and the previous frame; and a panel driver to display the previous frame, the intermediate frame and the current frame on the display panel in sequence.

The motion estimator may calculate the plurality of motion prediction error values by applying a block matching algorithm (BMA) to the current block and the searching region in the previous frame, and estimate the provisional motion vector of the current block at a location having a minimum motion prediction error value among of the calculated plurality of motion prediction error values.

The pattern determiner may comprise an integral projector to create a plurality of projected values by applying integral projection to the plurality of motion prediction error values; a projected value checker to count a number of local minimum projected values which are located between a predetermined first projected value and a predetermined second projected value of the plurality of projected values and are less than the first and second projected values; a period calculator to calculate the number of times a period including at least one of the local minimum projected values of the plurality of projected values is repeated in the searching region, and to calculate the period by dividing a length of the searching region by the number of times the period is repeated in the searching region; and a pattern discriminator to determine whether the current block includes the pattern image by analyzing the number of local minimum projected values and the number of times the period is repeated in the searching region.

The plurality of projected values may comprise a plurality of vertical projected values obtained by vertically applying the integral projection to the plurality of motion prediction error values, and a plurality of horizontal projected values obtained by horizontally applying the integral projection to the plurality of motion prediction error values.

The projected value checker may count a number of local minimum vertical projected values located between a predetermined first vertical projected value and a predetermined second vertical projected value and less than the first and second vertical projected values of the plurality of vertical projected values, and a number of local minimum horizontal projected values located between a predetermined first horizontal projected value and a predetermined second horizontal projected value and that are less than the first and second horizontal projected values of the plurality of horizontal projected values.

The period calculator may calculate the number of times a vertical period including at least one of the local minimum vertical projected values is repeated in the searching region, and a number of times a horizontal period including at least one of the local minimum horizontal projected values is repeated in the searching region.

The number of times the vertical and horizontal periods are repeated in the searching region may be respectively calculated by the following equations

$${γ}_{v} = \frac{{L}_{v , a}}{2 \cdot {L}_{v , p}} and {γ}_{h} = \frac{{L}_{h , a}}{2 \cdot {L}_{h , p}}$$

where γᵥ indicates the number of times the vertical period is repeated in the searching region, L_{v,a} indicates a vertical projected length obtained by a sum of absolute differences between two sequential vertical projected values of the plurality of vertical projected values, L_{v,p} indicates an absolute difference between a maximum and minimum vertical projected values of the plurality of vertical projected values, γₕ indicates the number of times the horizontal period is repeated in the searching region, L_{h,a} indicates a horizontal projected length obtained by a sum of absolute differences between two sequential horizontal projected values of the plurality of vertical projected values, and L_{h,p} indicates an absolute difference between a maximum and minimum vertical projected values of the plurality of horizontal projected values.

The period calculator may calculate the vertical period of the pattern image by dividing a horizontal length of the searching region by the number of times the vertical period is repeated therein, and the horizontal period of the pattern image by dividing a vertical length of the searching region by the number of times the horizontal period is repeated therein.

The pattern discriminator may determine that the current block includes the pattern image when the number of local minimum projected values in the searching region is at least two and the number of times the period is repeated in the searching region is larger than a first critical value.

The display apparatus may further comprise a pattern sorter to sort out either a static pattern image due to zero motion in the current block or a dynamic pattern image due to motion in the current block in the pattern image according to a location of a local minimum of the plurality of motion prediction error values nearest to a center of the searching region when the current block is determined to include the pattern image by the pattern determiner.

The pattern sorter may sort out the pattern image by comparing the period calculated by the period calculator with the local minimum of the plurality of motion prediction error values nearest to the center of the searching region selected from among at least one local minimum of the plurality of motion prediction error values which are located between a predetermined first motion prediction error value and a predetermined second motion prediction error value and is less than the first and second motion prediction error values of the plurality of the motion prediction error values.

The pattern sorter may determine the pattern image as the static pattern image when u<α·p is satisfied, where u indicates the location of the local minimum motion prediction error value nearest to the center of the searching region, α is a predetermined constant, and p indicates the period calculated by the period calculator.

The compensation motion vector creator may comprise a static motion vector creator to estimate and create the compensation motion vector for the current block at the location corresponding to the local minimum motion prediction error value nearest to the center of the searching region when the current block is sorted as the static pattern image by the pattern sorter; an average vector calculator to calculate an average vector of motion vectors of surrounding blocks adjacent to the current block in the current frame when the current block is sorted as the dynamic pattern image by the pattern sorter; and a dynamic motion vector creator to estimate and create the compensation motion vector for the current block at the location of the local minimum motion prediction error value nearest to the average vector selected from among the number of local minimum motion prediction error values.

The motion vector selector may output the compensation motion vector for the current block created by the static motion vector creator as the final motion vector when the pattern image is sorted as the static pattern image by the pattern sorter, and the compensation motion vector created by the dynamic motion vector creator as the final motion vector when the pattern image is sorted as the dynamic pattern image by the pattern sorter.

The plurality of motion prediction error values may be calculated by one of a sum of absolute difference (SAD), a mean absolute difference (MAD), and a mean square error (MSE).

The foregoing and/or other aspects of the present general inventive concept may also be achieved by providing a display apparatus comprising a display panel; a motion estimator to divide a current frame into a plurality of blocks having a predetermined size and to estimate a provisional motion vector of a current block by a global searching method; a compensation motion vector creator to calculate a plurality of motion prediction error values by applying a block matching algorithm (BMA) to the current block to estimate a motion among the plurality of blocks by estimating a plurality of respective provisional motion vectors, and to create at least one compensation motion vector for the current block according to at least one of the plurality of motion prediction error values that is less than or equal to a predetermined threshold value; a motion vector selector to calculate correlations between the at least one compensation motion vector and the provisional motion vectors of surrounding blocks adjacent to the current block, and to output one of the at least one compensation motion vector and the provisional motion vector as a final motion vector of the current block according to the correlations thereof; a motion compensator to create an intermediate frame according to the final motion vector and to insert the intermediate frame between the current frame and a previous frame; and a panel driver to display the previous frame, the intermediate frame, and the current frame on the display panel in sequence.

The motion estimator may calculate the plurality of motion prediction error values using the block matching algorithm (BMA) and calculate the plurality of provisional motion vectors corresponding to each of the plurality of blocks at a location having a minimum motion prediction error value of the plurality of calculated motion prediction error values.

The compensation motion vector creator may set a searching region having a predetermined size in the previous frame according to a relative position of the current block in the current frame, calculate the plurality of motion prediction error values by applying the block matching algorithm (BMA) to the current block and the searching region in the previous frame, and set the predetermined threshold value by multiplying a minimum motion prediction error value of the plurality of motion prediction error values by a predetermined constant.

The motion vector selector may comprise a correlation calculator to calculate the correlations between each of the at least one compensation motion vector and the provisional motion vectors of the surrounding blocks adjacent to the current block; and a final motion vector estimator to determine the compensation motion vector having a maximum correlation to be the final motion vector for the current block.

The correlation calculator may calculate the correlations by the following equation,

$$\frac{1}{D ( {v}_{c} )} = \frac{1}{{\sum }_{k} \vert {v}_{c} - {v}_{k} \vert} , k = 1 , 2 , 3 , … , M$$

where 1/D(v_{c}) indicates the correlations between each of the at least one compensation motion vector and the provisional motion vectors of the surrounding blocks; v_{c} indicates each of the at least one compensation motion vector; vₖ indicates the provisional motion vectors of each of the surrounding blocks; and M indicates a number of surrounding blocks.

The correlation calculator may calculate the correlations in a temporal direction by allowing the surrounding blocks to include a previous block of the previous frame that corresponds to a relative location of the current block in the current frame, and at least one block adjacent to the previous block.

The motion vector selector may further comprise a weight assigner to assign corresponding weights based on a similarity between the current block and each of the surrounding blocks, and the correlation calculator may calculate the correlations by the following equation,

$$\frac{1}{D ( {v}_{c} )} = \frac{1}{{\sum }_{k} {w}_{k} \vert {v}_{c} - {v}_{k} \vert} , k = 1 , 2 , 3 , … , M$$

where 1/D(v_{c}) indicates a correlation between each of the at least one compensation motion vector and the provisional motion vectors of the surrounding blocks; v_{c} indicates each of the at least one compensation motion vector; vₖ indicates the provisional motion vector of each surrounding block; M indicates a number of the surrounding blocks; wₖ indicates a corresponding weight.

The plurality of motion prediction error values are calculated by one of a sum of absolute difference (SAD), a mean absolute difference (MAD), and a mean square error (MSE).

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a view illustrating a time integral of a pixel value along a moving direction of a moving object;

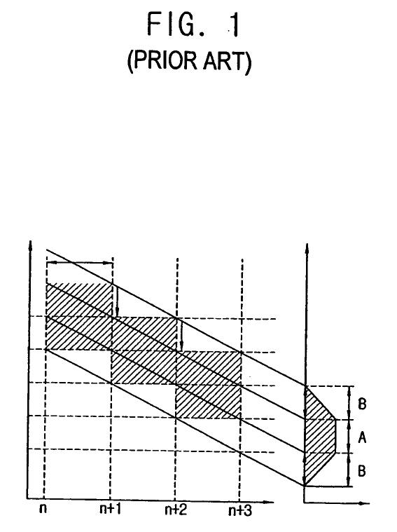

FIG. 2 is a control block diagram illustrating a display apparatus according to an embodiment of the present general inventive concept;

FIG. 3 is a view illustrating a time integral of pixel values that are integrated along a moving direction of a moving object when an intermediate frame is inserted between two sequential frames in the display apparatus of FIG. 2;

FIG. 4 is a control block diagram illustrating a motion estimator and a motion vector compensator of the display apparatus of FIG. 2;

FIG. 5 is a graph illustrating a portion of a sum of absolute difference (SAD) map calculated by the motion estimator of FIG. 4 in a three-dimensional coordinate system;

FIG. 6 is a graph illustrating a plurality of vertical projected values created from the SAD map of FIG. 5;

FIG. 7 is an SAD map for a static pattern image in a two dimensional coordinate system;

FIG. 8 is an SAD map for a dynamic pattern image in the two dimensional coordinate system;

FIG. 9 is a control block diagram illustrating a display apparatus according to another embodiment of the present general inventive concept;

FIG. 10 is a view illustrating a correlation calculated by a correlation calculator of the display apparatus of FIG. 9; and

FIG. 11 is a view illustrating a weight assignment made by a weight assigner of the display apparatus of FIG. 9.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

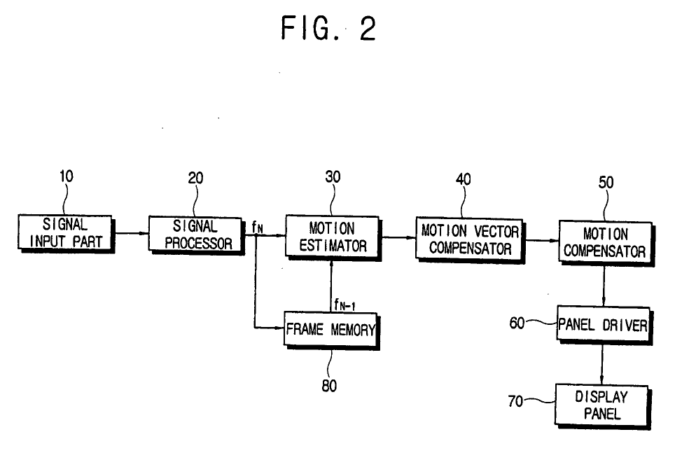

As illustrated in FIG. 2, a display apparatus according to an embodiment of the present general inventive concept comprises a signal input part 10, a signal processor 20, a motion estimator 30, a motion vector compensator 40, a motion compensator 50, a panel driver 60, and a display panel 70.

The display panel 70 displays a picture according to controls thereof. The display panel 70 may include an LCD panel. The display panel 70 may include other various types of display panels, such as a plasma display panel (PDP), in which a motion blur effect occurs when displaying the picture.

The signal processor 20 converts a format of an input video signal to be processed by the panel driver 60. For example, the signal processor 20 may comprise a scaler to scale the input video signal and a signal converter to convert the input video signal to be processed by the scaler. The signal converter may include an analog/digital (A/D) converter, a video decoder, a tuner, etc., according to various formats in which the input video signal is received.

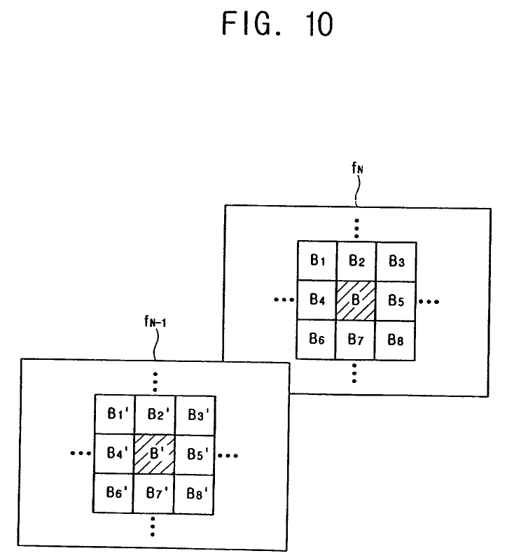

The motion estimator 30 divides an input current frame fₙ into a plurality of blocks each having a predetermined size (see FIG. 10). The motion estimator 30 estimates a provisional motion vector for a block (hereinafter, referred to as a “current block” B) for which motion will be estimated among the plurality of blocks in the current frame fₙ. Additionally, the motion estimator 30 estimates provisional motion vectors for the other blocks not including the current block B (hereinafter, referred to as “surrounding blocks” B1 through B8).

The motion estimator 30 estimates the provisional motion vector in order to compensate for the motion according to a block matching algorithm (BMA). Here, the BMA compares two frames block by block and estimates one provisional motion vector per block according to relative motion between the blocks that are compared.

The motion vector compensator 40 creates at least one compensating motion vector to estimate a final motion vector to approximate a real motion vector of a moving picture according to the provisional motion vectors estimated by the motion estimator 30. Further, the motion vector compensator 40 creates the final motion vector by analyzing the provisional motion vectors and the at least one compensating motion vector. The motion vector compensator 40 will be described in more detail below.

The motion compensator 50 creates an intermediate frame between the current frame f_{N} and a previous frame fₙ₋₁ according to the final motion vector output from the motion vector compensator 40 and inserts the intermediate frame between the current frame fₙ and the previous frame fₙ₋₁, thereby outputting the intermediate frame, the current frame fₙ, and the previous frame fₙ₋₁ to the panel driver 60.

The panel driver 60 drives the display panel 70 to display the previous frame fₙ₋₁, the intermediate frame, and the current frame fₙ in sequence. The panel driver 60 processes these frames at a speed twice as fast as an ordinary processing speed so that a picture that corresponds to the input video signal is displayed at an original speed. For example, when a video signal of 60 Hz is input to the display apparatus, the panel driver 60 processes the frame at a processing speed of 120 Hz, thereby driving the display panel 70 to display the picture at the original speed.

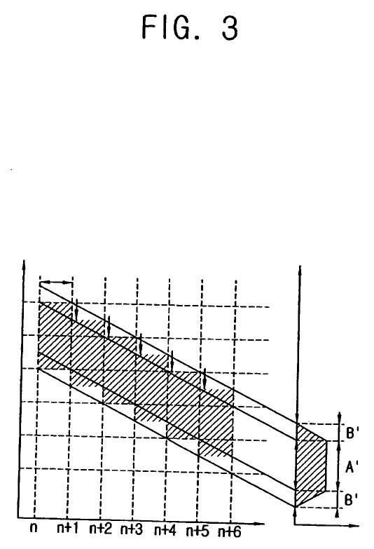

FIG. 3 illustrates a time integral of pixel values that are integrated along a moving direction of a moving object when an intermediate frame determined by estimating the motion of the moving object is inserted between two sequential frames. The pixel values may be understood to refer to a brightness or a luminescence of pixels in a frame of a picture. As illustrated in FIG. 3, inserting the intermediate frame between a previous frame fₙ₋₁ and a current frame fₙ causes pixel values that correspond to an error area between a moving path of the moving object and a pixel value holding region to have a markedly decreased effective difference, thereby decreasing the motion blur effect and improving visual recognition.

Hereinbelow, a display apparatus according to an embodiment of the present general inventive concept will be described with reference to FIGS. 2 and 4 to 8.

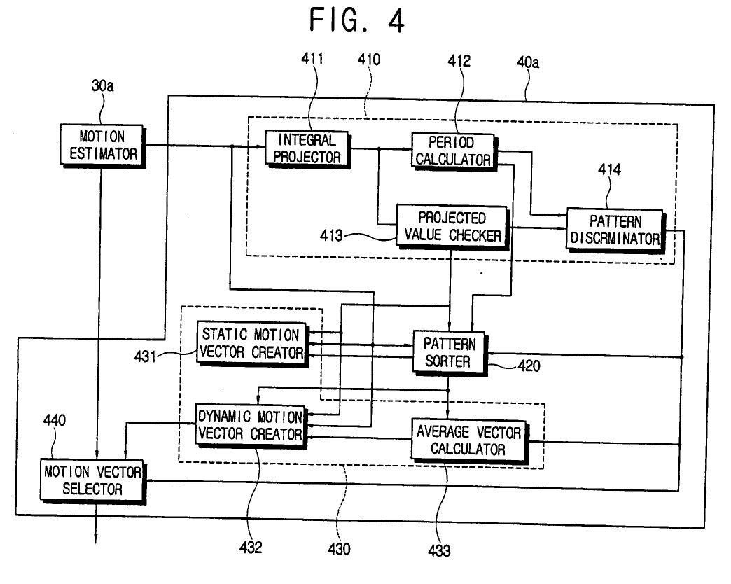

In the display apparatus, a motion estimator 30a in the display apparatus illustrated in FIG. 4 divides an input current frame fₙ into a plurality of blocks each having a predetermined size, and estimates a provisional motion vector of each of the plurality of blocks. The motion estimator 30a compares the current block B (see FIG. 10) from which a final motion vector will be estimated with a searching region set in the previous frame fₙ₋₁, thereby calculating a plurality of motion prediction error values. Here, information about the previous frame fₙ₋₁ is stored in a frame memory 80 (see FIG. 2), and provided to the motion estimator 30a when the provisional motion vector of each of the plurality of blocks in the current frame fₙ is estimated.

The plurality of motion prediction error values can be estimated by various well-known methods, such as a bidirectional block matching algorithm, a unidirectional block matching algorithm, etc., as long as the method can be used to estimate the provisional motion vector of each of the plurality of blocks included in the current frame fₙ and/or the previous frame fₙ₋₁, Further, the plurality of motion prediction error values can be replaced with a mean absolute difference (MAD), a mean square error (MSE), a sum of absolute difference (SAD), etc. The SAD is used herein to calculate the plurality of motion prediction error values and to explain the general inventive concept.

The motion estimator 30a calculates a plurality of SADs and estimates the provisional motion vector of the current block B according to a block that corresponds to a minimum SAD selected from among the plurality of calculated SADs.

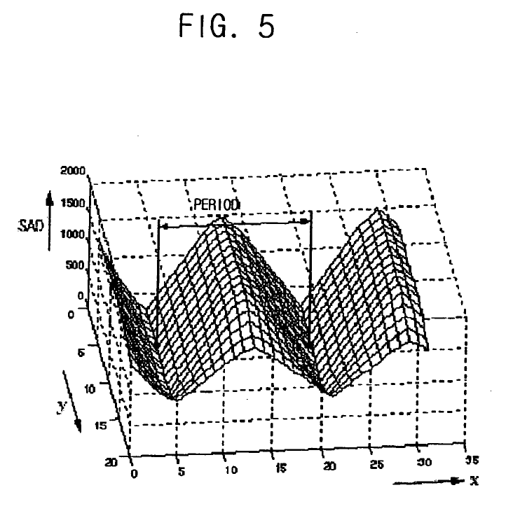

The plurality of SADs calculated by the motion estimator 30a can form an SAD map, and a size of the SAD map may be equal to that of a set searching region (K×K). FIG. 5 is a graph illustrating a portion of the SAD map in a three-dimensional coordinate system.

Referring to FIG. 5, “x” indicates a horizontal axis of the searching region, and “y” indicates a vertical axis of the searching region. For example, an SAD corresponding to (x, y)=(0, 5) is “1,500”. Here, the plurality of SADs that constitute the SAD map may be calculated by the foregoing block matching algorithm.

The SAD map of the current block B is provided to a pattern determiner 410, a pattern sorter 420, and a compensation motion vector creator 430, which are provided in a motion vector compensator 40a (to be described below). Further, the provisional motion vector of the current block B is given to a motion vector selector 440 (to be described below).

According to the present embodiment of the general inventive concept, the motion vector compensator 40a comprises the pattern determiner 410, the compensation motion vector creator 430, and the motion vector selector 440.

The pattern determiner 410 determines whether the current block B includes a pattern image according to the SAD map calculated by the motion estimator 30a, i.e., according to the plurality of SADs in the searching region. Here, the pattern image indicates an image repeated at predetermined intervals, which will be referred to as a “periodic pattern image” hereinafter.

As illustrated in FIG. 4, the pattern determiner 410 comprises an integral projector 411, a projected value checker 413, a period calculator 412, and a pattern discriminator 414. Here, the pattern determiner 410 determines whether the current block B includes the periodic pattern image according to vertical and horizontal characteristics of the SAD map. Hereinafter, a process of determining a horizontal periodic pattern will be described. A process of determining a vertical periodic pattern is similar to the process of determining the horizontal periodic pattern, and repetitive descriptions thereof will be omitted as necessary.

The integral projector 411 applies an integral projection to the SAD map of the current block B, thereby creating a plurality of integral vectors (hereinafter, referred to as “projected value”). As the projected value is determined in this manner, picture quality deterioration due to noise is minimized. The integral projector 411 determines a horizontal integral projection and a vertical integral projection. Hereinbelow, the vertical integral projection of the integral projector 411 will be described by way of example. The horizontal integral projection may be similarly determined.

The integral projector 411 applies the vertical integral projection to the SAD map of the current block B in a vertical direction, thereby creating a plurality of vertical projected values. That is, the integral projector 411 performs the vertical integral projection to determine the vertical periodic pattern along a horizontal direction. For example, the SAD map having a matrix of (K×K) is transformed into the plurality of vertical projected values having a matrix of (K×1).

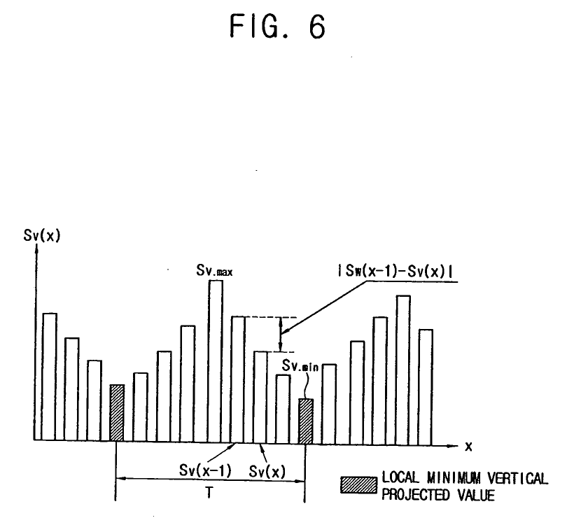

FIG. 6 is a graph illustrating the plurality of vertical projected values created from the SAD map of FIG. 5. Here, an x^{th} vertical projected value created by the vertical integral projection is calculated by the following [equation 1].

$${S}_{v} ( x ) = {\sum }_{y = 0}^{K - 1} E ( x , y ) \qquad [ equation 1 ]$$

Referring to FIG. 6 and [equation 1], x indicates a horizontal axis of the searching region, Sᵥ(x) indicates an x^{th} vertical projected value, E(x,y) indicates a motion prediction error value (i.e., an SAD corresponding to a provisional motion vector (x, y)). K indicates a total number of SADs along the y-axis in the searching region.

The integral projector 411 calculates a plurality of horizontal projected values in the same manner as that it calculates the plurality of vertical projected values. Here, a y^{th} horizontal projected value created by the horizontal integral projection is calculated by the following [equation 2].

$${S}_{h} ( y ) = {\sum }_{x = 0}^{K - 1} E ( x , y ) \qquad [ equation 2 ]$$

where y indicates a vertical axis of the searching region, Sₕ(y) indicates a y^{th} horizontal projected value, E(x,y) indicates a motion prediction error value (i.e., an SAD corresponding to a provisional motion vector (x, y)). K indicates a total number of SADs on the x-axis in the searching region.

The plurality of vertical and horizontal projected values determined by the integral projector 411 are provided to the projected value checker 413.

With respect to both the plurality of vertical and horizontal projected values, the projected value checker 413 checks a number of local minimum projected values of the plurality of projected values determined by the integral projector 411. Here, the local minimum projected value may range between a predetermined first projected value and a predetermined second projected value, and/or may be less than both the first projected value and the second projected values.

The projected value checker 413 checks a number of local minimum vertical projected values of the plurality of vertical projected values, and a number of local minimum horizontal projected values of the plurality of horizontal projected values.

A local minimum vertical projected value may range between a first vertical projected value and a second vertical projected value of the plurality of vertical projected values, and/or may be less than the first and second vertical projected values. Referring to FIG. 6, when a predetermined vertical projected value Sᵥ(x) is less than two adjacent vertical projected values Sᵥ(x−1) and Sᵥ(x+1), the vertical projected value Sᵥ(x) is classified as a local minimum vertical projected value.

Likewise, a local minimum horizontal projected value may range between a first horizontal projected value and a second horizontal projected value among the plurality of horizontal projected values, and/or may be less than the first and second horizontal projected values. Here, the projected value checker 413 transmits location information about the checked local minimum horizontal and vertical projected values to the pattern sorter 420 and the compensation motion vector creator 430.

The period calculator 412 calculates a number of times a period including at least one of the local minimum projected values of the plurality of projected values is repeated in the searching region. Further, the period calculator 412 divides a length or a size of the searching region by the calculated number of times the period is repeated in the searching region, thereby calculating the period.

The period calculator 412 calculates a number of times a vertical period is repeated in the searching region and a number of times a horizontal period is repeated in the searching region. Here, the number of times the vertical period is repeated in the searching region is calculated by the following [equation 3]. The vertical period indicates the period containing at least one of the local minimum vertical projected values sequentially appearing among the plurality of vertical projected values determined by the integral projector 411.

$${γ}_{v} = \frac{{L}_{v , a}}{2 \cdot {L}_{v , p}} = \frac{{\sum }_{x = 0}^{K} \vert {S}_{v} ( x - 1 ) - {S}_{v} ( x ) \vert}{2 \cdot ( {S}_{v , max} - {S}_{v , min} )} \qquad [ equation 3 ]$$

where γᵥ indicates the number of times the vertical period is repeated in the searching region, L_{v,a} indicates a vertical projected length obtained by a sum of absolute differences (SAD) taken between two sequential vertical projected values over a horizontal interval extending a horizontal length of the searching region, and L_{v,p} indicates an absolute difference between maximum and minimum vertical projected values of the plurality of vertical projected values.

Referring to [equation 3], the absolute difference between the maximum and minimum vertical projected values refers to a difference between vertical projected values appearing a half period apart so that the number of times the vertical period is repeated can be calculated by the [equation 3]. Hence, (2·L_{v,p}) refers to the difference between the maximum and the minimum vertical projected values that can be multiplied by two to obtain a length of one vertical period.

Here, the period calculator 412 calculates the vertical period by the following [equation 4].

$${T}_{v} = \frac{K}{{γ}_{v}} \qquad [ equation 4 ]$$

where Tᵥ indicates the vertical period, K indicates the horizontal length of the searching region, and γᵥ indicates the number of times the vertical period is repeated in the searching region.

Referring to [equation 4], the period calculator 412 calculates the vertical period by dividing the horizontal length of the searching region with the number of times the vertical period is repeated.

Further, the period calculator 412 calculates the number of times the horizontal period is repeated by the following [equation 5], in a similar manner in which the number of times the vertical period is repeated is calculated. Here, the horizontal period indicates the period containing at least one of the local minimum horizontal projected values sequentially appearing among the plurality of horizontal projected values determined by the horizontal integral projection.

$${γ}_{h} = \frac{{L}_{h , a}}{2 \cdot {L}_{h , p}} = \frac{{\sum }_{y = 0}^{K} \vert {S}_{h} ( y - 1 ) - {S}_{h} ( y ) \vert}{2 \cdot ( {S}_{h , max} - {S}_{h , min} )} \qquad [ equation 5 ]$$

where γₕ indicates the number of times the horizontal period is repeated in the searching region, L_{h,a} indicates a horizontal projected length obtained by a sum of absolute differences taken between two sequential horizontal projected values over a vertical interval extending a vertical length of the searching region, and L_{h,p} indicates an absolute difference between maximum and minimum horizontal projected values (S_{h,max}, S_{h,min}) of the plurality of horizontal projected values.

Referring to [equation 5], the absolute difference between the maximum and minimum horizontal projected values refers to a difference between horizontal projected values appearing a half period apart so that the number of times the horizontal period is repeated can be calculated by the [equation 5]. Hence, (2·L_{h,p}) refers to the difference between the maximum and minimum horizontal projected values that can be multiplied by two to obtain a length of one horizontal period.

Here, the period calculator 412 calculates the horizontal period by the following [equation 6].

$${T}_{h} = \frac{K}{{γ}_{h}} \qquad [ equation 6 ]$$

where Tₕ indicates the horizontal period, K indicates the vertical length of the searching region, and γₕ indicates the number of times the horizontal period is repeated in the searching region.

Referring to [equation 6], the period calculator 412 calculates the horizontal period by dividing the vertical length of the searching region by the number of times the horizontal period is repeated.

With respect to both the plurality of horizontal projected values and the plurality of vertical projected values, the pattern discriminator 414 analyzes the number of local minimum projected values checked by the projected value checker 413, and the number of times the period is repeated calculated by the period calculator 412, thereby determining whether the current block B includes the periodic pattern image. That is, the pattern discriminator 414 determines that the current block B includes the periodic pattern image when the number of local minimum projected values in the searching region is at least two and the number of times the period is repeated is larger than a first critical value.

For example, when determining the horizontal periodic pattern, the pattern discriminator 414 determines that the current block B includes the horizontal periodic pattern when the number of local minimum vertical projected values checked by the projected value checker 413 is at least two and the vertical period is larger than a first critical value of 1.17. Further, in the case of determining the vertical periodic pattern, a first critical value for the horizontal direction may be equal to or different from 1.17.

With respect to determining the vertical and the horizontal periodic patterns, when the pattern discriminator 414 determines that the current block B includes the periodic pattern image, the pattern sorter 420 sorts out either a static pattern image or a dynamic pattern image in the periodic pattern image according to whether a location of a local minimum motion prediction error value is nearest to a center of the searching region, which means there is no motion in the current block B. The static pattern image refers to a case when the periodic pattern image is included in the current block B and has no real motion (zero motion), while the dynamic pattern image refers to a case when the periodic pattern image is included in the current block B and includes real motion.

That is, the pattern sorter 420 compares the local minimum motion prediction error value nearest to the center of the searching region with the period of the periodic pattern image calculated by the periodic calculator 412, thereby sorting out the horizontal periodic pattern and the vertical periodic pattern by determining whether they are the static pattern image or the dynamic pattern image. Here, the local minimum motion prediction error value may range between a first motion prediction error value and a second motion prediction error value in the SAD map, and/or may be less than the first motion prediction error value and the second motion prediction error value.

For example, the pattern sorter 420 sorts out the static pattern image in the horizontal periodic pattern when the local minimum motion prediction error values satisfy the following [equation 7], and sorts out the dynamic pattern image in the horizontal periodic pattern image when the local minimum motion prediction error values do not satisfy the following [equation 7].
|x′|<α·T_{ν} [equation 7]
where |x′| indicates a location of the local minimum motion prediction error value nearest to the center of the searching region, Tᵥ indicates the vertical period, and α is a predetermined constant (e.g., α=⅛).

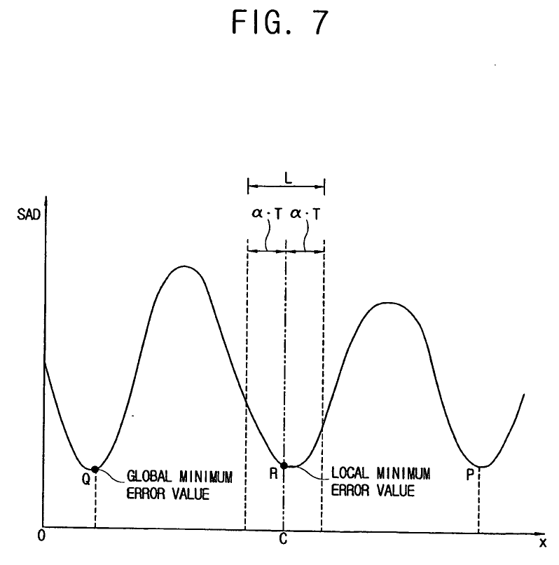

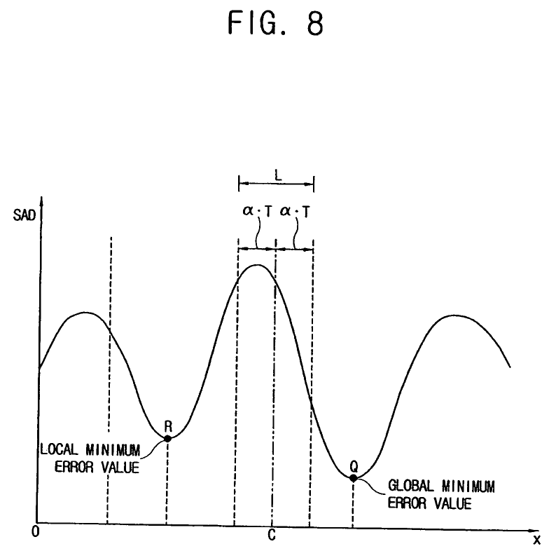

FIG. 7 is an SAD map of a static pattern image, and FIG. 8 is an SAD map of a dynamic pattern image. FIGS. 7 and 8 are graphs illustrating a middle region L of the searching region in the SAD map of FIG. 5 in a two-dimensional coordinate system.

Referring to [equation 7] and FIG. 7, P and R are local minimum motion prediction error values, Q is a global minimum motion prediction error value, C is the center of the searching region at which the motion of the current block B is zero, and L defines the middle region surrounding the center of the searching region C and extends on both sides of C by α·T, which is a preset range used to sort the periodic pattern image. In this case, the pattern sorter 420 sorts out the horizontal periodic pattern determined by the pattern determiner 410 as the static pattern image when the local minimum motion prediction error value R nearest to the center C of the searching region is located within the middle region L. Here, the global minimum motion prediction error value Q refers to the minimum SAD selected from among the plurality of SADs that form the SAD map.

On the other hand and referring to FIG. 8, the pattern sorter 420 sorts out the horizontal periodic pattern determined by the pattern determiner 410 as the dynamic pattern image when the global minimum motion prediction error value Q, which also happens to be the local minimum motion prediction error value nearest to the center C of the searching region in this case, is located beyond the middle region L.

Further, the pattern sorter 420 sorts the vertical periodic pattern using the following [equation 8] in the same manner as the horizontal periodic pattern is sorted.
|x′|<α·Tₕ [equation 8]

The compensation motion vector creator 430 creates a compensation motion vector of the current block B using the SAD map when the current block B is determined to include the periodic pattern image. Here, the compensation motion vector creator 430 creates the compensation motion vector according to the vertical periodic pattern and/or the horizontal periodic pattern determined by the pattern determiner 410.

The location of the local minimum motion prediction error value of the periodic pattern image moves according to motion of the periodic pattern image so that the compensation motion vector creator 430 creates the compensation motion vector of the current block B according to the motion of the periodic pattern image. That is, the compensation motion vector creator 430 compensates the motion vector according to the sorted results from the pattern sorter 420. Thus, the compensation motion vector creator 430 comprises a static motion vector creator 431, a dynamic motion vector creator 432, and an average vector calculator 433.

The static motion vector creator 431 creates the compensation motion vector for the current block B determined by the pattern sorter 420 to include the static pattern image. The static motion vector creator 431 creates the compensation motion vector at the local minimum motion prediction error value nearest to the center of the searching region, for example, at a location R in FIG. 7. Thus, the other local minimum motion prediction error values (i.e., P and Q in FIG. 7) are prevented from being determined as the final motion vector.

The compensation method used in the static motion vector creator 431 creates a consistent motion vector in a plurality of blocks that form one periodic pattern image. Therefore, the periodic pattern image is interpolated using an estimated vector (i.e., the consistent motion vector), thereby decreasing a pattern mismatch between the plurality of blocks and decreasing a block artifact.

On the other hand, when the pattern sorter 420 determines that the periodic pattern image of the current block B includes the dynamic pattern image, the average vector calculator 433 calculates an average vector of motion vectors of the surrounding blocks B1 through B8 adjacent to the current block B (see FIG. 10), before creating the compensation motion vector. The provisional motion vector of each surrounding block B1 through B8 can be regarded as the final motion vector provided from the motion vector selector 440.

The dynamic motion vector creator 432 estimates the provisional motion vector of the current block B according to the average vector of motion vectors of the surrounding blocks B1 through B8. Referring to FIG. 8, the dynamic motion vector creator 432 creates the compensation motion vector at the local minimum motion prediction error value R nearest to the average vector calculated from at least one of the local minimum motion prediction error values. When the current block B includes the dynamic pattern image, it may be impossible to determine which one of the local minimum motion prediction error values indicates the real motion. As a result, the compensation motion vector of the current block B is created according to correlations between the provisional motion vectors of the surrounding blocks B1 through B8. The compensation motion vector is created by the static motion vector creator 431 and is transmitted to the motion vector selector 440 through the dynamic motion vector creator 432.

The motion vector selector 440 selects one of the provisional motion vector estimated by the motion estimator 30a and the compensation motion vector created by the compensation motion vector creator 430 as the final motion vector according to discrimination results of the pattern discriminator 414.

When the pattern determiner 410 determines that the current block B does not include the periodic pattern image, the motion vector selector 440 selects the provisional motion vector estimated by the motion estimator 30a as the final motion vector. On the other hand, when the pattern determiner 410 determines that the current block B includes the periodic pattern image, the motion vector selector 440 selects the compensation motion vector created by either the static motion vector creator 431 or the dynamic motion vector creator 432 as the final motion vector.

That is, when the current block B is determined to include the periodic pattern image by the pattern discriminator 414 and the periodic pattern image is sorted as the static pattern image by the pattern sorter 420, the motion vector selector 440 selects the compensation motion vector created by the static motion vector creator 431 as the final motion vector. Further, when the current block B is determined to include the periodic pattern image by the pattern discriminator 414 and the periodic pattern image is sorted as the dynamic pattern image by the pattern sorter 420, the motion vector selector 440 selects the compensation motion vector created by the dynamic motion vector creator 432 as the final motion vector.

The motion compensator 50 (see FIG. 2) creates the intermediate frame according to final motion vectors corresponding to all blocks the foregoing processes. Further, the intermediate frame is inserted between the current frame f_{N} and the previous frame fₙ₋₁ so that the intermediate frame, the current frame f_{N} and the previous frame fₙ₋₁ are output to the panel driver 60.

The panel driver 60 displays the previous frame fₙ₋₁, the intermediate frame, and the current frame fₙ on the display panel 70, in sequence. The panel driver 60 processes these frames at the speed twice as fast as the ordinary processing speed so that a picture is displayed at the original speed.

According to the present embodiment of the general inventive concept, when the current block B is determined to include the periodic pattern image by the pattern discriminator 414, the pattern sorter 420, the static motion vector creator 431, and the dynamic motion vector creator 432 may read out location information of the local minimum motion prediction error values checked by the projected value checker 413, and thereby perform their respective operations.

In the present embodiment, the period calculator 412 calculates the vertical period and the horizontal period regardless of the discrimination results of the pattern discriminator 414. Alternatively, the period calculator 412 may calculate the vertical period and the horizontal period only when the current block B is determined to include the periodic pattern image by the pattern discriminator 414.

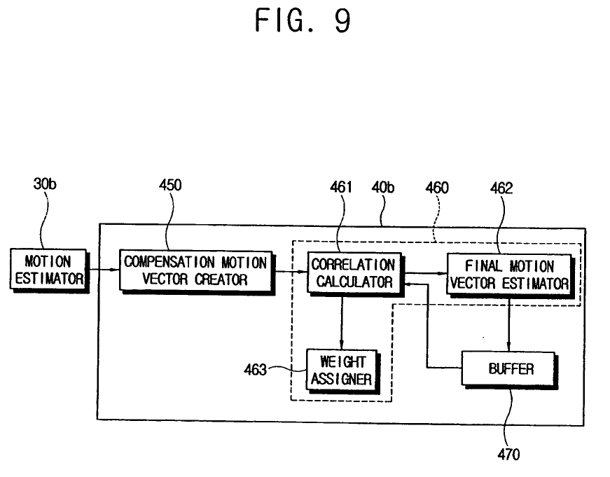

Hereinbelow, a display apparatus according to another embodiment of the present general inventive concept will be described with reference to FIG. 9.

In the display apparatus according to the present embodiment of the general inventive concept, a motion estimator 30b divides a current frame fₙ into a plurality of blocks each having a predetermined size, and estimates a provisional motion vector of each of the plurality of blocks. Like the motion estimator 30a (see FIG. 4) according to the previous embodiment of the present general inventive concept, the motion estimator 30b calculates a plurality of motion prediction error values by applying the block matching algorithm (BMA) to each of the plurality of blocks. Further, the motion estimator 30b estimates a provisional motion vector of each block at a location corresponding to a minimum motion prediction error value.

Similar to the previous embodiment, the plurality of the motion prediction error values can be calculated by various methods such as a sum of absolute differences (SAD) method, a mean of absolute differences (MAD) method, etc. The SAD is used herein to calculate the plurality of motion prediction error values and to explain the general inventive concept.

A motion vector compensator 40b according to the present embodiment creates a final motion vector according to correlations between the plurality of blocks. The motion vector compensator 40b according to the present embodiment comprises a compensation motion vector creator 450, a motion vector selector 460, and a buffer 470.

The compensation motion vector creator 450 estimates a compensation motion vector of a current block B using a prescreening method. That is, the compensation motion vector creator 450 applies the BMA to the current block B among the plurality of blocks, thereby estimating at least one compensation motion vector of the current block B.

In particular, the compensation motion vector creator 450 sets a searching region of a predetermined size in the previous frame_{fn-1} with respect to the current block B, and then applies the BMA to the current block B and the set searching region, thereby calculating a plurality of SADs (i.e., the plurality of motion prediction error values).

Further, the compensation motion vector creator 450 estimates the at least one compensation motion vector of the current block B at a location that corresponds to an SAD selected from the plurality of SADs having a value that is less than or equal to a set threshold value. That is, a number of compensation motion vectors is equal to the SADs having values less than or equal to the set threshold value. According to the present embodiment, a minimum SAD selected from among the plurality of SADs is multiplied by a predetermined constant “a” (i.e., a×minimum SAD). The compensation motion vectors having SAD values that are less than the threshold value may include one or more compensation motion vectors, but will hereinafter be referred to in plural as “the compensation motion vectors.”

The value of a×minimum SAD is used to accurately estimate the final motion vector of the current block B according to a possibility that a motion vector that corresponds to the real motion of the current block B is included in the compensation motion vectors having an SAD that is less than the a×minimum SAD (i.e., the threshold value). According to the present embodiment, “a” may be 0.5, but is not limited thereto and may vary.

The motion vector selector 460 can comprise a correlation calculator 461 and a final motion vector estimator 462 (see FIG. 9).

The correlation calculator 461 calculates correlations between the estimated compensation motion vectors and the provisional motion vectors of surrounding blocks B1 through B8. The correlation calculator 461 employs the prescreening method to calculate the correlations between the estimated compensation motion vectors and the provisional motion vector of each of the surrounding blocks B1 through B8. As a measure to calculate the correlations between the estimated compensation motion vectors and the provisional motion vectors of each of the surrounding blocks B1 through B8, a distance vector can be used. Here, the correlations can be calculated by the following [equation 9].

$$\frac{1}{D ( {v}_{c} )} = \frac{1}{{\sum }_{k} \vert {v}_{c} - {v}_{k} \vert} , k = 1 , 2 , 3 , … , M \qquad [ equation 9 ]$$

where 1/D(v_{c}) indicates a correlation between each of the compensation motion vectors and each of the provisional motion vectors of the surrounding blocks B1 through B8; D(v_{c}) indicates a distance vector; v_{c} indicates each compensation motion vector; vₖ indicates a provisional motion vector of each surrounding block B1 through B8; and M indicates a number of surrounding blocks B1 through B8.

Further, the surrounding blocks B1 through B8 are adjacent to the current block B. When only considering a spatial correlation, the surrounding blocks B1 through B8 indicate blocks included in the current frame fₙ surrounding the current block B.

Referring to FIG. 9, the correlations calculated by the correlation calculator 461 are inversely proportional to D(v_{c}). Hence, the smaller D(v_{c}), the stronger the correlation.

The correlation calculator 461 calculates the correlations in a temporal direction as well as the spatial direction (see FIG. 10). In this case, the correlation calculator 461 calculates the spatial and temporal correlations according to the provisional motion vector of the previous block B′ that corresponds to the relative location of the current block B in the previous frame fₙ₋₁ prior to the current frame fₙ and according to the provisional motion vector of at least one of the blocks B1′ through B8′ adjacent to the previous block B′.

That is, the previous block B′ and at least one of blocks B1′ through B8′ surrounding the previous block B′ of the previous frame fₙ₋₁ as well as the surrounding blocks B1 through B8 of the current frame fₙ illustrated in FIG. 10 are determined to be the blocks adjacent to the current block B. A provisional motion vector of each block B′, B1′ through B8′ of the previous frame fₙ₋₁ includes the final motion vector of each block that is to be selected by the motion vector selector 460 (to be described below).

Further, a number of the surrounding blocks B1 through B8 used in the correlation calculator 461 may be adjusted to correspond to a sampling frequency of an image and the predetermined size of the plurality of divided blocks. For example, as the sampling frequency of the image (i.e., an image resolution) increases and/or as the predetermined size of the divided blocks decreases, the surrounding blocks B1 through B8 used in the correlation calculator 461 are spatially and temporally extended.

The final motion vector estimator 462 estimates the compensation motion vector having a maximum correlation selected from among the correlations calculated by the [equation 9] as the final motion vector. Thus, the provisional motion vector of the current block B estimated by the motion estimator 30b through the BMA is compensated according to the correlations with the surrounding blocks B1 through B8, thereby estimating the final motion vector.

The buffer 470 temporarily stores the final motion vector of each block of the current frame fₙ selected by the final motion vector estimator 462 for each frame. The temporarily stored final motion vector is used while the correlation calculator 461 considers the temporal correlation.

The correlation calculator 461 can assign weights according to a similarity between the current block B and each surrounding block B1 through B8. Thus, the motion vector selector 460 comprises a weight assigner 463, as illustrated in FIG. 9.

The weight assigner 463 calculates the weights according to the similarity between the current block B and each surrounding block B1 through B8. Here, the weight assigner 463 assigns a higher weight to the surrounding blocks B1 through B8 according if they have an image characteristic that is similar to the current block B. The similarity in the image characteristic is used as a measure to determine whether the current block B and each surrounding block B1 through B8 have the same motion, a similar motion, or different motions.

The weight assigner 463 determines the similarity in the image characteristics using a measure, such as a gradient, a texture, an average value of pixels, a distribution of pixels, etc., between the current block B and each surrounding block B1 through B8. For example, the weight assigner 463 calculates the gradient of the current block B and the gradient of each of the surrounding blocks B1 through B8, and assigns a weight equal to an inverse proportion of a difference between theses gradients. That is, the weight assigner 463 determines that the current block B and one of the surrounding blocks B1 through B8 have similar image characteristics when the difference between the gradient of the current block B and the gradient of the one of the surrounding blocks B1 through B8 is less. To calculate the weights, the weight assigner 463 receives pixel information about the current frame fₙ and/or the previous frame fₙ₋₁ including, for example, information about brightness of each pixel. When considering the texture as the measure of similarity, the weight assigner 463 assigns a weight equal to an inverse proportion of a difference of the average value of the pixels, the distribution of the pixels, etc.

The weight assigning method may be used to estimate the motion vector of the blocks about two objects having different motions.

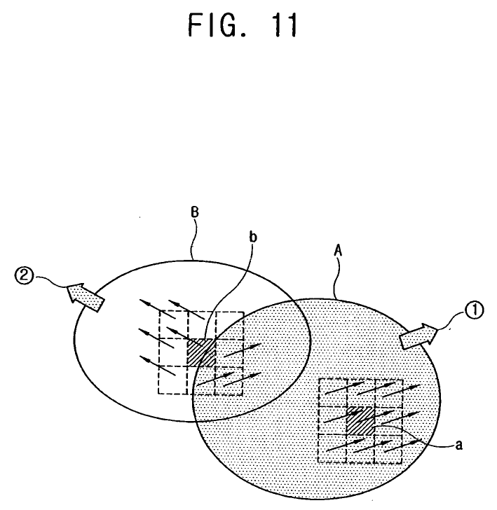

Referring to FIG. 11, an object A moving in direction 1 including the current block B and the surrounding blocks B1 through B8 have vector components of the same direction. Therefore, to compensate the provisional motion vector of the current block B incorrectly estimated due to noise, the motion vector compensator 40b can compensate the provisional motion vector of the current block B using the provisional motion vectors of the surrounding blocks B1 through B8 without assigning weights thereto.

On the other hand, in the case of an object B moving in direction of 2, because the respective surrounding blocks are included in both the objects A and B, it may be impossible to accurately compensate the provisional motion vector of the current block B on which two objects A and B having different motions that are superposed. In this case, the motion vector compensator 40b assigns a higher weight to the provisional motion vectors of the surrounding blocks B1 through B8 having image characteristics that are more similar to the current block B, thereby more accurately compensating the motion. That is, the higher weight is assigned to the surrounding blocks B1 through B8 having a higher similarity with the current block B, thereby more accurately performing motion compensation.

In addition to calculating weights when the objects A and B have different motions, the weights can also be calculated and assigned when the objects A and B have the same motions or similar motions.

The weights calculated by the weight assigner 463 is provided to the correlation calculator 461, and the correlation calculator 461 can calculate the correlations to reflect the weights by the following [equation 10].

$$\frac{1}{D ( {v}_{c} )} = \frac{1}{{\sum }_{k} {w}_{k} \vert {v}_{c} - {v}_{k} \vert} , k = 1 , 2 , 3 , … , M \qquad [ equation 10 ]$$

where 1/D(v_{c}) indicates a correlation between each of the compensation motion vectors and the provisional motion vectors of each of the surrounding blocks B1 through B8; wₖ indicates each weight; v_{c} indicates each compensation motion vector; vₖ indicates a provisional motion vector of each surrounding block B1 through B8; and M indicates the number of surrounding blocks B1 through B8.

The [equation 10] is equal to the [equation 9] except that [equation 10] assigns the weights. Therefore, repetitive description will be omitted.

Further, the weight assigner 463 determines the similarity between each block of the previously stored frame fₙ₋₁ as well as the current frame fₙ and the current block B, thereby calculating the weights to be assigned by the [equation 10].

Here, the final motion vector estimator 462 estimates the compensation motion vector having a maximum correlation selected from among the correlations calculated by the [equation 10] as the final motion vector for the current block B. The estimated final motion vector of each block is temporarily stored in the buffer 470 for each frame.

Thus, according to the present embodiment of the general inventive concept, the motion vector of the current block B is estimated according to the correlation between the blocks, thereby providing an image without block artifact.

As described above, the present general inventive concept provides a display apparatus in which an intermediate frame is created using a motion compensating method based on a real motion of a moving picture, and the intermediate frame is inserted between a current frame and a previous frame, thereby minimizing a motion blur effect.

The present general inventive concept provides a display apparatus in which a motion vector is accurately estimated even though it is located in a pattern region in which it is difficult to correctly estimate a motion vector, thereby eliminating a block artifact.

Further, the present general inventive concept provides a display apparatus in which incorrectly estimated motion vectors of blocks are correctly compensated and estimated using provisional motion vectors of surrounding blocks so that a block artifact is eliminated, thereby displaying a natural visual image.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus comprising:
a display panel;
a motion estimator to divide a current frame into a plurality of blocks having a predetermined size, to calculate a plurality of motion prediction error values by comparing a current block for estimating a motion thereof among the plurality of blocks of the current frame with a searching region set in a previous frame, and to estimate a provisional motion vector of the current block according to the plurality of motion prediction error values;
a pattern determiner to determine whether the current block includes a pattern image according to the plurality of motion prediction error values;
a compensation motion vector creator to create a compensation motion vector for the current block according to the plurality of motion prediction error values when the current block is determined to include the pattern image by the pattern determiner;
a motion vector selector to select the compensation motion vector as a final motion vector of the current block when the current block is determined to include the pattern image by the pattern determiner, and to select the provisional motion vector as the final motion vector of the current block when the current block is not determined to include the pattern image by the pattern determiner;
a motion compensator to create an intermediate frame according to the final motion vector and to insert the intermediate frame between the current frame and the previous frame; and
a panel driver to display the previous frame, the intermediate frame, and the current frame on the display panel in sequence.

2. The display apparatus according to claim 1, wherein the motion estimator calculates the plurality of motion prediction error values by applying a block matching algorithm (BMA) to the current block and the searching region in the previous frame, and estimates the provisional motion vector of the current block at a location having a minimum motion prediction error value of the calculated plurality of motion prediction error values.

3. The display apparatus according to claim 1, wherein the pattern determiner comprises:
an integral projector to create a plurality of projected values by applying integral projection to the plurality of motion prediction error values;
a projected value checker to count a number of local minimum projected values which are located between a predetermined first projected value and a predetermined second projected value of the plurality of projected values, and are less than the first and second projected values;
a period calculator to calculate a number of times a period including at least one of the local minimum projected values of the plurality of projected values is repeated in the searching region, and to calculate the period by dividing a length of the searching region by the number of times the period is repeated in the searching region; and
a pattern discriminator to determine whether the current block includes the pattern image by analyzing the number of local minimum projected values and the number of times the period is repeated in the searching region.

4. The display apparatus according to claim 3, wherein the plurality of projected values comprise a plurality of vertical projected values obtained by vertically applying the integral projection to the plurality of motion prediction error values, and a plurality of horizontal projected values obtained by horizontally applying the integral projection to the plurality of motion prediction error values.

5. The display apparatus according to claim 4, wherein the projected value checker counts a number of local minimum vertical projected values located between a predetermined first vertical projected value and a predetermined second vertical projected value and less than the first and second vertical projected values of the plurality of vertical projected values, and a number of local minimum horizontal projected values located between a predetermined first horizontal projected value and a predetermined second horizontal projected value and that are less than the first and second horizontal projected values of the plurality of horizontal projected values.

6. The display apparatus according to claim 5, wherein the period calculator calculates the number of times a vertical period including at least one of the local minimum vertical projected values is repeated in the searching region, and the number of times a horizontal period including at least one of the local minimum horizontal projected values is repeated in the searching region.

7. The display apparatus according to claim 6, wherein the number of times the vertical and horizontal periods are repeated in the searching region are respectively calculated by the following equations
$${γ}_{v} = \frac{{L}_{v , a}}{2 \cdot {L}_{v , p}} and {γ}_{h} = \frac{{L}_{h , a}}{2 \cdot {L}_{h , p}}$$
where γᵥ indicates the number of times the vertical period is repeated in the searching region, L_{v,a} indicates a vertical projected length obtained by a sum of absolute differences between two sequential vertical projected values of the plurality of vertical projected values, L_{v,p} indicates an absolute difference between a maximum and minimum vertical projected values of the plurality of vertical projected values, γₕ indicates the number of times the horizontal period is repeated in the searching region, L_{h,a} indicates a horizontal projected length obtained by a sum of absolute differences between two sequential horizontal projected values among the plurality of horizontal projected values, and L_{h,p} indicates an absolute difference between a maximum and minimum horizontal projected values of the plurality of horizontal projected values.

8. The display apparatus according to claim 6, wherein the period calculator calculates the vertical period of the pattern image by dividing a horizontal length of the searching region by the number of times the vertical period is repeated therein, and the horizontal period of the pattern image by dividing a vertical length of the searching region by the number of times the horizontal period is repeated therein.

9. The display apparatus according to claim 3, wherein the pattern discriminator determines that the current block includes the pattern image when the number of local minimum projected values in the searching region is at least two and the number of times the period is repeated is larger than a first critical value.

10. The display apparatus according to claim 3, further comprising:
a pattern sorter to sort out either a static pattern image due to zero motion in the current block or a dynamic pattern image due to motion in the current block in the pattern image according to a location of a local minimum of the plurality of motion prediction error values nearest to a center of the searching region when the current block is determined to include the pattern image by the pattern determiner.

11. The display apparatus according to claim 10, the pattern sorter sorts out the pattern image by comparing the period calculated by the period calculator with the local minimum of the plurality of motion prediction error values nearest to the center of the searching region selected from among at the plurality of motion prediction error values which is located between a predetermined first motion prediction error value and a predetermined second motion prediction error value and is less than the first and second motion prediction error values of the plurality of motion prediction error values.

12. The display apparatus according to claim 11, wherein the pattern sorter determines the pattern image as the static pattern image when u<α·p is satisfied, where u indicates the location of the local minimum motion prediction error value nearest to the center of the searching region, α is a predetermined constant, and p indicates the period calculated by the period calculator.

13. The display apparatus according to claim 11, wherein the compensation motion vector creator comprises:
a static motion vector creator to estimate and create the compensation motion vector for the current block at the location corresponding to the local minimum motion prediction error value nearest to the center of the searching region when the current block is sorted as the static pattern image by the pattern sorter;
an average vector calculator to calculate an average vector of the motion vectors of surrounding blocks adjacent to the current block in the current frame when the current block is sorted as the dynamic pattern image by the pattern sorter; and
a dynamic motion vector creator to estimate and create the compensation motion vector for the current block at the location of the local minimum motion prediction error value nearest to the average vector selected from among the plurality of motion prediction error values.

14. The display apparatus according to claim 13, wherein the motion vector selector outputs the compensation motion vector for the current block created by the static motion vector creator as the final motion vector when the pattern image is sorted as the static pattern image by the pattern sorter, and the compensation motion vector created by the dynamic motion vector creator as the final motion vector when the pattern image is sorted as the dynamic pattern image by the pattern sorter.

15. The display apparatus according to claim 1, wherein the plurality of motion prediction error values are calculated by one of a sum of absolute difference (SAD), a mean absolute difference (MAD), and a mean square error (MSE).

16. A display apparatus comprising:
a display panel;
a motion estimator to divide a current frame into a plurality of blocks having a predetermined size and to estimate a provisional motion vector of the current block by a global searching method;
a compensation motion vector creator to calculate a plurality of motion prediction error values by applying a block matching algorithm (BMA) to the current block to estimate a motion among the plurality of blocks by estimating a plurality of respective provisional motion vectors, and to create at least one compensation motion vector for the current block according to at least one of the plurality of motion prediction error values that is less than or equal to a predetermined threshold;
a motion vector selector to calculate correlations between the at least one compensation motion vector and the provisional motion vectors of surrounding blocks adjacent to the current block, and to output one of the at least one compensation motion vector and the provisional motion vector as a final motion vector of the current block according to the correlations thereof;
a motion compensator to create an intermediate frame according to the final motion vector and to insert the intermediate frame between the current frame and a previous frame; and
a panel driver to display the previous frame, the intermediate frame, and the current frame on the display panel, in sequence.

17. The display apparatus according to claim 16, wherein the motion estimator calculates the plurality of motion prediction error values using the block matching algorithm (BMA) and calculates the plurality of provisional motion vectors of each of the plurality of blocks at a location having a minimum motion prediction error value of the calculated plurality of motion prediction error values.

18. The display apparatus according to claim 16, wherein the compensation motion vector creator sets a searching region having a predetermined size in the previous frame according to a relative location of the current block in the current frame, calculates the plurality of motion prediction error values by applying the block matching algorithm (BMA) to the current block and the searching region in the previous frame, and sets the predetermined threshold value by multiplying a minimum motion prediction error value of the plurality of motion prediction error values by a predetermined constant.

19. The display apparatus according to claim 16, wherein the motion vector selector comprises:
a correlation calculator to calculate the correlations between each of the at least one compensation motion vector and the provisional motion vectors of the surrounding blocks adjacent to the current block; and
a final motion vector estimator to determine the compensation motion vector having a maximum correlation to be the final motion vector for the current block.

20. The display apparatus according to claim 19, wherein the correlation calculator calculates the correlations by the following equation,
$$\frac{1}{D ( {v}_{c} )} = \frac{1}{{\sum }_{k} \vert {v}_{c} - {v}_{k} \vert} , k = 1 , 2 , 3 , … , M$$
where 1/D(v_{c}) indicates the correlations between each of the at least one compensation motion vector and the provisional motion vectors of the surrounding blocks; v_{c} indicates each of the at least one compensation motion vector; vₖ indicates the provisional motion vector of each of the surrounding blocks; and M indicates a number of surrounding blocks.

21. The display apparatus according to claim 19, wherein the correlation calculator calculates the correlations in a temporal direction by allowing the surrounding blocks to include a previous block of the previous frame that corresponds to a relative location of the current block in the current frame and at least one block adjacent to the previous block.

22. The display apparatus according to claim 19, wherein the motion vector selector further comprises a weight assigner to assign corresponding weights based on a similarity between the current block and each of the surrounding blocks, and the correlation calculator calculates the correlations by the following equation,
$$\frac{1}{D ( {v}_{c} )} = \frac{1}{{\sum }_{k} {w}_{k} \vert {v}_{c} - {v}_{k} \vert} , k = 1 , 2 , 3 , … , M$$
where 1/D(v_{c}) indicates a correlation between each of the at least one compensation motion vector and the provisional motion vectors of the surrounding blocks; v_{c} indicates each of the at least one compensation motion vector; vₖ indicates the provisional motion vector of each of the surrounding blocks; M indicates a number of surrounding blocks; wₖ indicates a corresponding weight.

23. The display apparatus according to claim 16, wherein the motion prediction error value is calculated by one of a sum of absolute difference (SAD), a mean absolute difference (MAD), and a mean square error (MSE).

24. An image display apparatus, comprising:
a motion estimator to receive a video signal having at least a first frame and a second frame each having a plurality of blocks and to estimate a provisional motion vector therefrom;
a pattern determiner to calculate a plurality of motion prediction error values from the plurality of blocks with respect to a selected block in the second frame, to determine whether the selected block includes a periodic pattern image, and to generate projected values according to the plurality of motion prediction error values;
a compensation motion vector creator to determine a compensation motion vector according to the projected values and a determination of whether the selected block includes the periodic pattern image;
a motion vector selector to select one of the provisional motion vector and the compensation motion vector as a final motion vector according to the projected values, the determination, and the periodic pattern image; and
a motion compensator to create an intermediate frame to insert between the first frame and the second frame according to the final motion vector.

25. The apparatus according to claim 24, further comprising:
a pattern sorter to determine a static pattern image and a dynamic pattern image as a characteristic of the periodic pattern image,
wherein the compensation motion vector comprises a static motion vector and a dynamic motion vector and the motion vector selector selects one of the static motion vector and the dynamic motion vector as a characteristic of the selected block according to the static pattern image and the dynamic pattern image.

26. The apparatus according to claim 24, wherein the compensation motion vector creator generates a first motion vector and a second motion vector as the compensation motion vector, and the first motion vector is a static motion vector and the second motion vector is a dynamic motion vector.

27. The apparatus according to claim 24, wherein the compensation motion vector creator generates a first motion vector and a second motion vector as the compensation motion vector, and the compensation motion vector creator selects the second motion vector as the compensation motion vector according to a correlation of motion vectors of the blocks adjacent to the selected block.

28. The apparatus according to claim 24, wherein the pattern determiner selects one or more local minimum values from the projected values, and the compensation motion vector creator generates the compensation motion vector according to a position of the local minimum values of the projected values with respect to a center of a searching region of the first frame.

29. The apparatus according to claim 24, wherein the pattern determiner determines at least one of a vertical minimum value and a horizontal minimum value from the projected values, and the compensation motion vector creator generates the compensation motion vector according to the vertical minimum value and the horizontal minimum value.

30. The apparatus according to claim 24, wherein the pattern determiner determines a number of times a period including a local minimum value of the projected values is repeated in a searching region of the first frame and determines the periodic pattern image according to the number of times the period is repeated.

31. The apparatus according to claim 24, wherein the pattern determiner comprises:
a projected value checker to determine a number of local minimum values of the plurality of the projected values in a vertical and a horizontal direction in order to determine whether the selected block includes the periodic pattern image by determining whether a searching region includes at least one vertical local minimum and at least one horizontal local minimum.

32. The apparatus according to claim 24, further comprising:
a pattern sorter to determine whether any of the plurality of blocks in a searching region of the first frame are capable of accurately approximating motion of the selected block in the second frame according to the projected values.

33. The apparatus according to claim 32, wherein the compensation motion vector creator comprises:
an average vector calculator to calculate an average motion vector by averaging provisional vectors of blocks surrounding the selected block in the second frame, and
a dynamic motion vector creator to select a provisional motion vector of one of the plurality of blocks in the searching region having a local minimum projected value that is closest to the average motion vector as the compensation motion vector.

34. An image display apparatus to compensate for motion in a video signal having at least two frames, the apparatus comprising:
a motion estimator to estimate provisional motion vectors of a current block of a current frame, surrounding blocks of a current frame, and a plurality of blocks in a searching region of a previous frame;
a pattern determiner to calculate a plurality of projected motion values for the plurality of blocks in the searching region and to determine whether the plurality of projected motion values are periodic;
a compensation motion vector creator to provide a first compensation motion vector according to the provisional vectors of the plurality of blocks in the searching region and to provide a second compensation vector according to the provisional motion vectors of the surrounding blocks of the current frame and the plurality of blocks in the searching region of the previous frame; and
a motion vector selector to select the provisional vector of the current block if the pattern determiner determines that the plurality of projected motion values are not periodic and to select between the first and second compensation motion vectors when the pattern determiner determines that the plurality of projected motion values are periodic according to whether motion of the current block is capable of being reliably estimated using the provisional vectors of the plurality of blocks in the searching region of the previous frame.

35. The apparatus according to claim 34, wherein whether the motion of the current block is capable of being reliably estimated using the provisional vectors of the plurality of blocks in the searching region of the previous frame is determined by whether one of the plurality of blocks in the searching region matches the current block.

36. The apparatus according to claim 34, wherein the pattern determiner determines whether the plurality of projected motion values are periodic by calculating a number of local minimum values of the plurality of projected motion values in the searching region.

37. The apparatus according to claim 34, wherein the compensation motion vector creator provides the first compensation vector that corresponds to a provisional motion vector of one of the plurality of blocks in the searching region that has a local minimum projected motion value that is closest to a center of the searching region and provides the second compensation motion vector by selecting a provisional vector of one of the plurality of blocks in the searching region having a local minimum motion projected value that is closest to an average of the provisional motion vectors of the surrounding blocks.

38. The apparatus according to claim 37, wherein the motion vector selector selects the first compensation vector when the plurality of projected motion values are determined to be periodic and when the local minimum projected motion value falls within a predetermined range and selects the second compensation vector when the plurality of projected motion values are determined to be periodic and when the local minimum projected motion value does not fall within the predetermined range.

39. An image display apparatus to compensate for motion in a video signal having at least two frames, the apparatus comprising:
a motion estimator to estimate provisional motion vectors of a plurality of surrounding blocks that surround a current block in a current frame;
a compensation motion vector creator to calculate a plurality of motion prediction error values of each of the surrounding blocks with respect to the current block and to determine one or more motion compensation vectors by selecting provisional motion vectors corresponding to blocks having motion prediction error values that are less than or equal to a predetermined threshold;
a correlation calculator to calculate correlation values between the one or more motion compensation vectors and the provisional motion vectors of the surrounding blocks and selecting a motion compensation vector with a maximum correlation as a final motion compensation vector; and
a motion compensator to create an intermediate frame to insert between the current frame and a previous frame according to the final motion compensation vector.

40. The apparatus according to claim 39, wherein the surrounding blocks include blocks adjacent to the current block in the current frame, a previous block located in the same relative location in the previous frame as the current block in the current frame, and a block adjacent to the previous block in the previous frame.

41. The apparatus according to claim 39, further comprising:
a weight assigner to provide weights to the correlation calculator according to a similarity of image characteristics of the current block and the surrounding blocks to calculate weighted correlation values.

42. The apparatus according to claim 41, wherein the weight assigner calculating the weights according to a similarity of image characteristics of the current block and the surrounding blocks increases a likelihood that a compensation vector that is close to a surrounding block that has similar image characteristics to the current block will have the maximum correlation.

43. The apparatus according to claim 41, wherein the similarity of image characteristics is determined by one of a gradient, a texture, an average value of pixels, and a distribution of pixels.

44. A method of motion compensation, the method comprising:
receiving a video signal having at least a first frame and a second frame each having a plurality of blocks and to estimate a provisional motion vector;
calculating a plurality of motion prediction error values from the plurality of blocks with respect to a selected block in the second frame, determining whether the selected block includes a periodic pattern image, and generating projected values according to the plurality of motion prediction error values;
determining a compensation motion vector according to the projected values and a determination of whether the selected block includes the periodic pattern image;
selecting one of the provisional motion vector and the compensation motion vector as a final motion vector according to the projected values, the determination, and the periodic pattern image; and
creating an intermediate frame to insert between the first frame and the second frame according to the final motion vector.

45. The method according to claim 44, further comprising:
determining a static pattern image and a dynamic pattern image as a characteristic of the periodic pattern image,
wherein the compensation motion vector comprises a static motion vector and a dynamic motion vector and the motion vector selector selects one of the static motion vector and the dynamic motion vector as a characteristic of the selected block according to the static pattern image and the dynamic pattern image.

46. The method according claim 44, wherein the determining of the compensation motion vector comprises generating a first motion vector and a second motion vector as the compensation motion vector according to a characteristic of the periodic pattern image and the projected values.

47. The method according to claim 46, wherein the first motion vector is calculated according to a local minimum value of the projected values, and the second motion vector is calculated according to an average value of motion vectors of blocks adjacent to the selected block.

48. The method according to claim 47, wherein the first motion vector is selected as the compensation motion vector when the local minimum value of the projected values is spaced apart from a center of a searching region in the first frame by less than a predetermined distance.

49. The method according to claim 47, wherein the first motion vector is generated as a motion vector of a block in the first frame that corresponds to the local minimum value of the projected values.

50. The method according to claim 47, wherein the second motion vector is selected as the compensation motion vector when the local minimum value of the projected values is spaced apart from a center of a searching region in the first frame by more than a predetermined distance.

51. The method according to claim 47, wherein the first motion vector is a static motion vector and the second motion vector is a dynamic motion vector.

52. The method according to claim 47, wherein the second motion vector is generated as the compensation motion vector according to a correlation of motion vectors of the blocks adjacent to the selected block.

53. The method according to claim 44, further comprising:
selecting one or more local minimum values from the projected values, and
generating the compensation motion vector according to a position of the local minimum values of the projected values with respect to a center of a searching region of the first frame.

54. The method according to claim 44, further comprising:
determining at least one of a vertical minimum value and a horizontal minimum value from the projected values, and
generating the compensation motion vector according to the vertical minimum value and the horizontal minimum value.

55. The method according to claim 44, further comprising:
determining a number of times a period including a minimum value of the projected values is repeated in a searching region of the first frame, and
determining the periodic pattern image according to the number of times the period is repeated.

56. The method according to claim 44, further comprising:
determining a number of local minimum values of the plurality of the projected values in a vertical and a horizontal direction in order to determine whether the selected block includes the periodic pattern image by determining whether a searching region includes at least one vertical local minimum and at least one horizontal local minimum.

57. The method according to claim 44, further comprising:
determining whether any of the plurality of blocks in a searching region of the first frame are capable of accurately approximating motion of the selected block in the second frame according to the projected values.

58. A method of compensating motion, the method comprising:
determining whether there is motion in a video signal having two or more frames;
determining whether motion in a current frame can be accurately approximated using a block matching algorithm with respect to a previous frame; and
compensating motion using either blocks in the previous frame or both blocks in the previous frame and blocks in the current frame according to whether motion in the current frame can by accurately approximated using a block matching algorithm with respect to the previous frame.

59. A method of compensating motion, the method comprising:
receiving a video signal having two or more frames;
estimating provisional motion vectors of a plurality of surrounding blocks that surround a current block in a current frame;
calculating a plurality of motion prediction error values of each of the surrounding blocks with respect to the current block;
determining one or more motion compensation vectors by selecting provisional motion vectors corresponding to blocks having motion prediction error values that are less than or equal to a predetermined threshold;
calculating correlation values between the one or more motion compensation vectors and the provisional motion vectors of the surrounding blocks and selecting a motion compensation vector with a maximum correlation as a final motion compensation vector; and
creating an intermediate frame to insert between the current frame and a previous frame according to the final motion compensation vector.

60. The method according to claim 59, wherein the surrounding blocks include blocks adjacent to the current block in the current frame, a previous block located in the same relative location in the previous frame as the current block in the current frame, and a block adjacent to the previous block in the previous frame.

61. The method according to claim 59, wherein the plurality of motion prediction error values determine an amount of difference between motion of the current block and motion of each of the surrounding blocks.

62. The method according to claim 59, wherein determining one or more motion compensation vectors comprises determining which of the provisional vectors of the surrounding blocks more reliably approximates motion of the current block.

63. The method according to claim 59, wherein calculating correlation values between the one or more motion compensation vectors and the provisional motion vectors of the surrounding blocks comprises determining which of the one or more motion compensation vectors is closest to each of the provisional motion vectors of the surrounding blocks.

64. The method according to claim 59, wherein the calculating of the correlation values between the one or more motion compensation vectors and the provisional motion vectors of the surrounding blocks comprises weighting the correlation values according to a similarity of image characteristics of the current block and the surrounding blocks.

65. The method according to claim 64, wherein the weighting of the correlation values according to a similarity of image characteristics of the current block and the surrounding blocks increases a likelihood that a compensation vector that is close to a surrounding block that has similar image characteristics to the current block will have the maximum correlation.

66. The method according to claim 64, wherein the similarity of image characteristics is determined by one of a gradient, a texture, an average value of pixels, and a distribution of pixels.

67. A method of determining a compensation vector to create an intermediate frame, the method comprising:
receiving a video signal having at least a first frame and a second frame;
determining whether there is motion in a selected block of the second frame by comparing motion characteristics of blocks in the first frame with the selected block in the second frame;
outputting a provisional motion vector of the selected block in the second frame as the compensation vector when it is determined that a real motion of the selected block in the second frame can not be approximated with reference to the blocks of the first frame;
outputting a provisional vector of a block in the first frame that is determined to approximate the selected block in the second frame, when it is determined that there is no real motion in the selected block of the second frame; and
outputting a provisional vector of a block in the first frame that is determined to be closest to an average of provisional vectors for surrounding blocks in the second frame, when it is determined that there is real motion in the selected block of the second frame.
